(19) United States
(12) Patent Application Publication
(10) Pub. No.: US 2006/0133824 A1
(43) Pub. Date: Jun. 22, 2006

(54) Apparatus for stabilizing wavelength of optical source for optical communications

(76) Inventors: Seung Il Myong, Daejeon (KR); Youn Seon Jang, Daejeon (KR); Kwang Joon Kim, Daejeon (KR); Hyun Jae Lee, Daejeon (KR)

Correspondence Address: MAYER, BROWN, ROWE & MAW LLP, 1909 K STREET, N.W., WASHINGTON, DC, 20006, US

(21) Appl. No.: 11/264,384

(22) Filed: Nov. 2, 2005

(30) Foreign Application Priority Data
Dec. 20, 2004 (KR) 2004-108914

(51) Int. Cl. H04B 10/04

(52) U.S. Cl. 398/195

(57) ABSTRACT

Provided is an apparatus for stabilizing a wavelength for optical communications which includes a digital control circuit unit and an analog control circuit unit to stabilize a wavelength that may be shifted at the time of driving an optical source for optical communications. The wavelength can be precisely controlled according to a modulation format using the optical source for optical communications, and thus performance can be stabilized.

### CROSS-REFERENCE TO RELATED APPLICATION

This application claims priority to and the benefit of Korean Patent Application No. 2004-108914, filed Dec. 20, 2004, the disclosure of which is incorporated herein by reference in its entirety.

### BACKGROUND

1. Field of the Invention

The present invention relates to an apparatus for stabilizing a wavelength of an optical source for optical communications, and more particularly, to an apparatus for stabilizing a wavelength which includes a digital circuit and an analog circuit to stabilize the wavelength that may be shifted at the time of driving an optical source for optical communications.

2. Discussion of Related Art

In an optical communication system, demands for stabilization of a wavelength and a temperature of an optical source, especially a distributed feedback laser diode (DFB-LD) have increased due to necessity for [symbol] various optical signal modulation formats in addition to a conventional non-

A laser generally used as an optical source for an optical communication system is the DFB-LD. In the modulation format applied to the optical communication system, standards for an output optical intensity, a wavelength, a line width and a side mode suppression ratio of the DFB-LD have been suggested for the NRZ modulation. However, standards for stabilizing the optical source have not been suggested for newly-applied differential phase shift keying (DPSK).

Especially in 10 Gbps DPSK, a stabilization range is not obtained by general laser standards. On the other hand, a wavelength shift occurring in laser output of optical signals needs to be precisely controlled to stabilize the wavelength.

### SUMMARY OF THE INVENTION

The present invention is directed to implementation of a circuit for precisely stabilizing a wavelength in an optical modulation format requiring stabilization of a wavelength of an optical source for optical communications.

The present invention is also directed to implementation of an apparatus for stabilizing a wavelength that includes a digital control circuit unit and an analog control circuit unit to precisely stabilize a wavelength of an optical source for optical communications.

One aspect of the present invention is to provide an apparatus for stabilizing a wavelength for optical communications that detects and stabilizes a wavelength of an optical source, the apparatus including: a digital control circuit unit for receiving optical intensity measurement value information and wavelength measurement value information from the optical source, receiving temperature status information from an analog control circuit unit, and transmitting various information signals to the analog control circuit unit; and an analog control circuit unit coupled to the digital control circuit unit, for receiving temperature measurement value information from the optical source, transmitting the temperature status information on the basis of the received information, and transmitting a current control signal and a temperature control signal to the optical source on the basis of the various information signals.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic structural diagram of an apparatus for stabilizing an optical source for optical communications in accordance with an exemplary embodiment of the present invention;

FIG. 2 is a detailed structural diagram of the digital control circuit unit of FIG. 1;

FIG. 3 is a detailed structural diagram of the analog control circuit unit of FIG. 1;

FIG. 4 is a detailed structural diagram of an apparatus for stabilizing an optical source for optical communications in accordance with an exemplary embodiment of the present invention; and

FIG. 5 is a graph showing resultant data of stabilization of a wavelength in temperature variations (normal temperature +/−10°) in the example of the present invention.

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art. In the following description, same drawing reference numerals are used for the same elements even in different drawings, and explanations of the same elements are omitted.

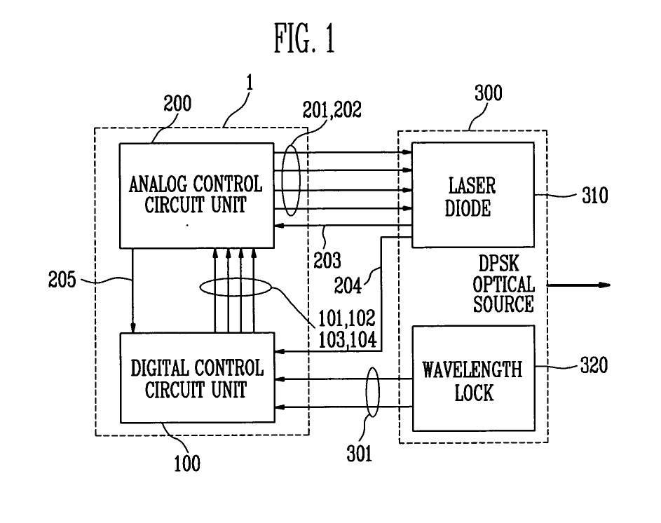

FIG. 1 is a schematic structural diagram of an apparatus 1 for stabilizing an optical source for optical communications in accordance with an exemplary embodiment of the present invention.

Analog and digital circuits are used together to control an optical source. However, it is also possible to individually install and use the analog and digital circuits according to precision in control or a control algorithm.

An optical source 300 can include a laser diode 310 and use a wavelength lock 320 inside or outside to stabilize a wavelength. Referring to FIG. 1, the optical source 300 includes the wavelength lock 320, and the wavelength lock 320 transmits wavelength measurement value information 301.

On the other hand, the apparatus 1 for stabilizing the optical source 300 includes an analog control circuit unit 200 and a digital control circuit unit 100.

The analog control circuit unit 200 transmits a current control signal 201 and a temperature control signal 202 to the laser diode 310, and receives temperature measurement value information 203 from the laser diode 310.

The digital control circuit unit 100 receives temperature status information 205 from the analog control circuit unit 200, and transmits various information signals 101, 102, 103 and 104 to the analog control circuit unit 200. These signals will later be explained in detail. The digital control circuit unit 100 receives optical intensity measurement value information 204 from the laser diode 310 to confirm an optical intensity, and also receives the wavelength measurement value information 301 from the wavelength lock 320.

The apparatus 1 for stabilizing the optical source 300 in accordance with the present invention will now be described in detail.

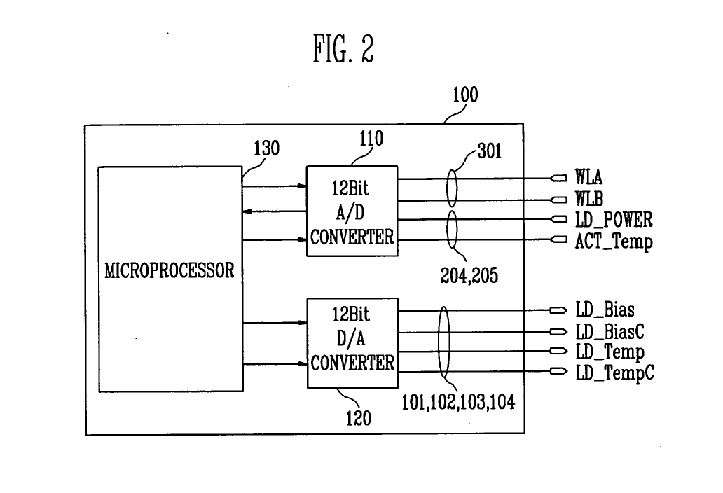

First, the digital control circuit unit 100 of the apparatus 1 of FIG. 1 will now be explained with reference to FIG. 2. FIG. 2 is a detailed structural diagram of the digital control circuit unit of FIG. 1.

As illustrated in FIG. 2, the digital control circuit unit 100 includes a microprocessor 130, a 12-bit A/D converter 110 and a 12-bit D/A converter 120.

The wavelength measurement value information 301 and the optical intensity measurement value information 204 transmitted from the optical source 300 and the temperature status information 205 transmitted from the analog circuit control unit 200 are sampled by the A/D converter 110 of the digital control circuit unit 100. The sampled information signals are calculated by the microprocessor 130, converted into the information signals 101, 102, 103 and 104 for stabilization control by the D/A converter 120, and transmitted to the analog control circuit unit 200.

The microprocessor 130 generates the various information signals 101, 102, 103 and 104 by using the calculated signals and the preset reference values, and transmits the generated signals 101, 102, 103 and 104 to the analog control circuit unit 200. Reference numeral 101 denotes a current initial set value signal, 102 denotes a current variation value signal, 103 denotes a temperature initial set value signal, and 104 denotes a temperature variation value signal.

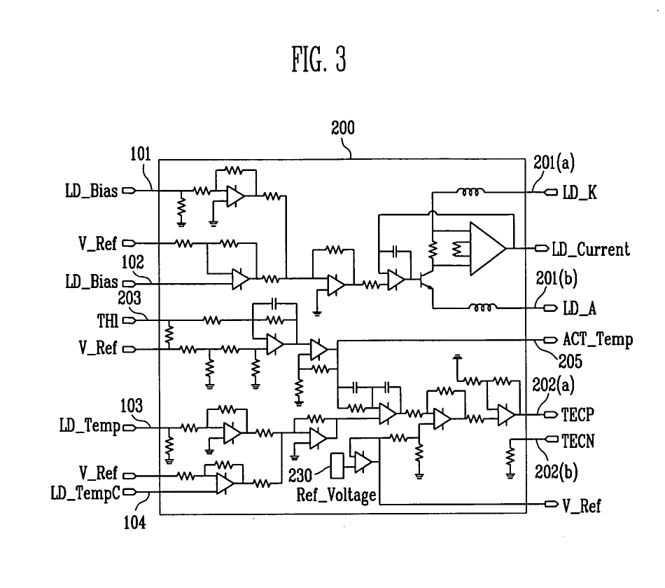

The analog control circuit unit 200 of the apparatus 1 of FIG. 1 will now be explained with reference to FIG. 3. FIG. 3 is a detailed structural diagram of the analog control circuit unit 200 of FIG. 1. The analog control circuit unit 200 includes an adder and a subtracter.

As shown in FIG. 3, in order to control the current of the laser diode 310, the analog control circuit unit 200 receives the current initial set value signal 101 and the current variation value signal 102 from the digital control circuit unit 100, analog-processes the received signals 101 and 102, and transmits current control signals 201a and 201b to the optical source 300.

So as to control the temperature, the analog control circuit unit 200 receives the temperature initial set value signal 103 and the temperature variation value signal 104 from the digital control circuit unit 100 and the temperature measurement value signal 203 of the laser diode 310 from the optical source 300, analog-processes the received signals 103, 104 and 203, and transmits the temperature control signal 202a and 202b to the laser diode 310. The optical intensity measurement value signal 204 and temperature status signal 205 are transmitted to the digital control circuit unit 100.

On the other hand, FIG. 3 only shows the essential structure of the analog control circuit unit 200 for stabilizing the wavelength of, for example, the DPSK.

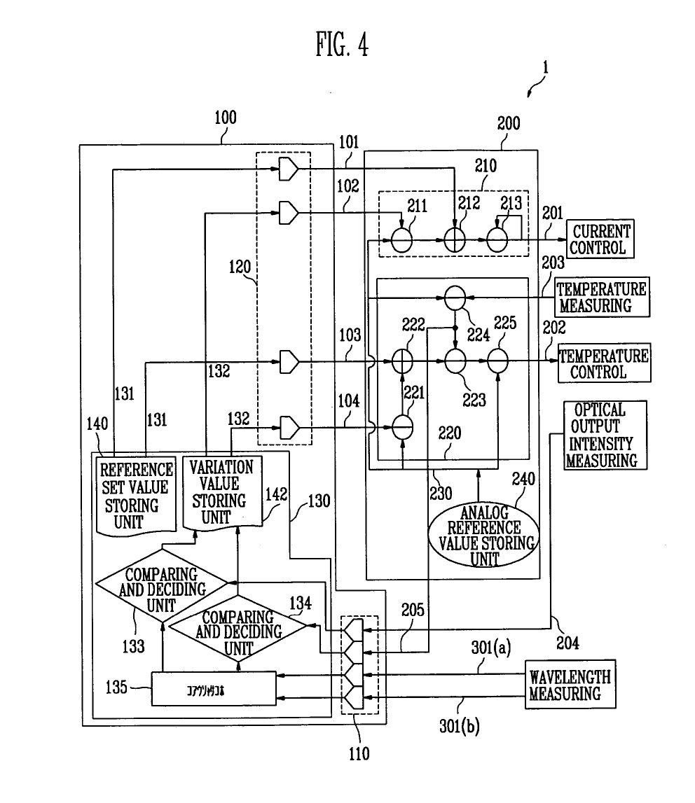

The apparatus 1 for stabilizing the wavelength of the optical source 300 for optical communications will now be described in more detail. FIG. 4 is a detailed structural diagram of an apparatus for stabilizing an optical source for optical communications in accordance with an exemplary embodiment of the present invention.

As depicted in FIG. 4, as described above, the apparatus 1 for stabilizing the optical source 300 includes an analog control circuit unit 200 and a digital control circuit unit 100.

In order to set an input current and an input temperature for obtaining a target output optical intensity and a target output wavelength, the user must preset and store current and temperature reference values in a reference set value storing unit 140 of the digital control circuit unit 100, and transmit a current initial set value signal 101 and a temperature initial set value signal 103 to the analog control circuit unit 200 through the D/A converter 120. In the case that relative changes occur in the optical source 300, the user transmits a current variation value signal 102 and a temperature variation value signal 104 to the analog control circuit unit 200 through the D/A converter 120.

Wavelength measurement value information 301a and 301b of the optical source 300 are transmitted to the digital control circuit unit 100 through, for example, a wavelength lock 320, processed by the microprocessor 130, and transmitted to the analog control circuit unit 200. The outputted control signals 201 and 202 are transmitted to the optical source 300 through the analog control circuit unit 200. Preferably, converters that can perform the sampling operation over 12 bits are employed as the A/D converter 110 and the D/A converter 120 to precisely control the wavelength.

The control procedure of correcting variations of the optical source 300 by the apparatus 1 for stabilizing the wavelength will now be explained.

First, the circuit structure for controlling the current is simply numerically expressed to confirm the method for correcting the current. The current control is performed by the following formula:
Current control signal 201=current initial set value signal 101−[current analog set value signal 230−current variation value signal 102]

The current analog set value signal 230 has been stored in the reference set value storing unit 240 and fixed to be used as a reference for a voltage. If there is no change, the current variation value signal 102 is identical to the current analog set value signal 230. Accordingly, only the current initial set value signal 101 exists, and the current is controlled as the current initial set value. However, if the optical output intensity changes due to variations of the external environment or deterioration of the optical source 300, the current variation reference value changes for control.

On the other hand, the method for correcting variations of noises in current control is essentially required to precisely control the current. Therefore, the current control circuit part needs a feedback process as indicated by reference numeral 213. If the current feedback is not performed, noises generated in the circuit in current control are transmitted to the optical source 300, and thus the current is imprecisely controlled. Preferably, for precise control of the wavelength, the current feedback function as indicated by reference numeral 213 is inserted into the current control circuit part in order to minutely control the current.

The circuit structure for controlling the temperature is simply numerically expressed to confirm the method for correcting the temperature. The temperature control is performed by the following formula:
Temperature control signal 202=3*temperature analog reference value signal 230−[temperature initial set value signal 103+temperature variation value signal 104+temperature measurement value signal 203]

Here, the functions of the subtracter 224 can be added to improve precision of wavelength control. For this, the temperature measurement value signal 203 can be applied to the adder 223. However, the temperature measurement value is quantized using the temperature analog reference value signal 230 to improve precision of temperature measurement. When noises exist both in the temperature analog reference signal 230 and the temperature measurement value signal 224, noises are offset by the subtracter 224, thereby measuring minute variations. The method for controlling and correcting the temperature controls the temperature according to the temperature variation value and measurement value.

On the other hand, the analog control circuit unit 200 has two parameters for controlling the optical source 300, namely, the circuit structure for controlling the current and temperature. Accordingly, when the two parameters are controlled at the same time to control the wavelength of the optical source 300, it is possible to maintain the stable wavelength and the constant optical output power. To maintain the predetermined optical output intensity and optical wavelength according to properties required in each modulation of the communication system is the important performance factor.

The operation of the apparatus 1 for stabilizing the wavelength for optical communications in accordance with the present invention will now be described in detail with reference to FIG. 4.

When the wavelength is varied due to the internal or external influences of the optical source 300, the wavelength measurement value information 301a and 301b is detected by the wavelength lock 320. The detected wavelength measurement value information 301a and 301b is transmitted to the microprocessor 130 through the A/D converter 110. The microprocessor 130 examines a wavelength variation factor to control the temperature and current. That is, the currently-displayed optical intensity measurement value information 204 and temperature status information 204 are required. In FIG. 4, the temperature status information 204 is inputted after passing through a predetermined procedure in the analog control circuit unit 200.

When the wavelength variation factor is the temperature, the temperature measurement value information 205 from a temperature measuring means (not shown) is varied. Therefore, a comparing and deciding unit 134 compares the temperature value with the previous temperature measurement value of the microprocessor 130, and varies the temperature control signal 104 for controlling the temperature. When the current is not sufficiently applied to the optical source 300 due to deterioration of the optical source 300, the optical intensity measurement value signal 204 from an optical output intensity measuring means (not shown) is varied due to variations of the optical output intensity. Accordingly, a comparing and deciding unit 133 compares the optical intensity value with the previous optical intensity measurement value of the microprocessor 130, and varies the current variation control value signal 102 for controlling the current.

The comparing and deciding units 133 and 134 can simultaneously or individually control the current and temperature. In addition, the variation factors can be simultaneously or individually generated. Mostly, the control operation varies the temperature control value, to cause variations of the current control. Therefore, the variation factors are generated at the same time. As a result, the current and temperature are controlled by the feedback operation on the control circuit, thereby controlling correction of the wavelength.

### EXAMPLE

In general, in the laser requirement standard of the 10 GHz WDM system, stabilization of the wavelength is <+/−0.02 nm (2.5 GHz) at an interval of 50 GHz channel. Therefore, the actually-obtained control resolution is about 0.005 nm. Such wavelength variations cause a penalty over 1 dB in 10 G DPSK transmission. More precise control is required. When a BER penalty for wavelength variations of the 10 Gb/s DPSK signal was measured, ˜1 dB of power penalty was generated in regard to 400 MHz laser wavelength variations. Thus, a locking circuit having control resolution below 0.002 nm (250 MHz) was designed to have a penalty below 0.3 dB. A wavelength lock was built in the optical source. A Nortel LD was used as an optical source. The temperature property of the Nortel LD was 0.112 nm/° C. When a 12-bit A/D converter and a 12-bit D/A converter were used, 0.01° C. of temperature control resolution and <0.002 nm of wavelength control resolution were obtained.

The implemented apparatus for stabilizing the wavelength for optical communications measured stabilization of the wavelength for over 15 hours at a normal temperature. As a result, 100 MHz of stabilization was obtained. Although it was impossible to measure stabilization below the resultant value due to resolution limits of the wavelength measuring device, the DPSK modulation could be applied at a normal temperature with the resultant value.

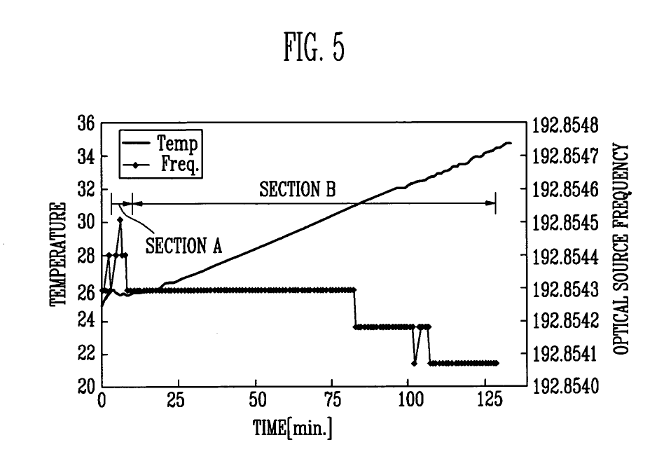

FIG. 5 is a graph showing resultant data of stabilization of the wavelength in temperature variations (normal temperature +/−10°) by the apparatus for stabilizing the wavelength for optical communications of FIG. 4. The measurement section is divided into A and B sections. In A section, when a thermostat is used to cause artificial temperature environment variations, data do not exist within a normal measurement range due to serious temperature variations by initial state setting of the thermostat, and thus are ignored. Actually, the normal temperature environment of the thermostat exists in section B. Because the data measured in section B are selected, variations are measured within the range of +/−200 MHz.

As discussed earlier, in accordance with the present invention, when the wavelength must be precisely controlled according to modulations using the optical source for optical communications, performance can be stabilized. For example, in the optical source applied to 10 Gbps DPSK of the optical communication system, the wavelength shift occurring in laser output of optical signals can be precisely controlled to stabilize the wavelength. In addition, the wavelength of the DFB-LD used as the optical source of 10 Gbps DPSK optical communications can be precisely controlled.

The DPSK receiving unit obtains stabilized system performance without any corrections by improving stabilization of the wavelength. Accordingly, stabilization of the wavelength of the general optical source (+/−2.5 GHz˜5 GHz) can be improved to +/−200 MHz.

Considering that general stabilization of the wavelength is performed within the precision range below 2.5˜5 GHz, the apparatus of the present invention achieves high stabilization of the wavelength.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for stabilizing a wavelength for optical communications that stabilizes a wavelength of an optical source, the apparatus comprising:
a digital control circuit unit for receiving optical intensity measurement value information and wavelength measurement value information from the optical source, receiving temperature status information from an analog control circuit unit, and transmitting various information signals to the analog control circuit unit; and
the analog control circuit unit coupled to the digital control circuit unit, for receiving temperature measurement value information from the optical source, transmitting the temperature status information on the basis of the received information, and transmitting a current control signal and a temperature control signal to the optical source on the basis of the various information signals.

2. The apparatus according to claim 1, wherein the optical source comprises a laser diode and a wavelength lock.

3. The apparatus according to claim 2, wherein the wavelength measurement value information is outputted from the wavelength lock.

4. The apparatus according to claim 1, wherein the digital control circuit unit comprises:
an A/D converter for sampling the wavelength measurement value information and the optical intensity measurement value information from the optical source and the temperature status information from the analog circuit control unit;
a microprocessor for calculating the sampled signals; and
a D/A converter for outputting the various information signals using the signals calculated by the microprocessor and preset reference values.

5. The apparatus according to claim 4, wherein the A/D converter and the D/A converter perform the sampling operation over 12 bits.

6. The apparatus according to claim 1, wherein the analog control circuit unit comprises an adder and a subtracter.

7. The apparatus according to claim 1, wherein the analog control circuit unit further comprises a current feedback function.
